(19) United States
(12) Patent Application Publication
(10) Pub. No.: US 2015/0014065 A1
(43) Pub. Date: Jan. 15, 2015

(54) CORE BARREL VALVE ASSEMBLY

(71) Applicant: ATLAS COPCO CANADA INC., Dallard-des-Ormeaux (CA)

(72) Inventors: Paul Lambert, North Bay (CA); Patrick Salvador, North Bay (CA); Patrick Lu, North Bay (CA)

(73) Assignee: ATLAS COPCO CANADA INC., Dallard-des-Ormeaux, QC (CA)

(21) Appl. No.: 14/375,107

(22) PCT Filed: Jan. 25, 2013
(86) PCT No.: PCT/CA2013/050051

§ 371 Date: Jul. 28, 2014

(51) Int. Cl. E21B 34/08; F16K 35/06

(52) U.S. Cl. CPC E21B 34/08; F16K 35/06
USPC 175/317; 137/515; 137/383; 137/14

(57) ABSTRACT

A valve assembly for use in an inner tube member of a core barrel head assembly positionable within a drill string of a drilling apparatus. The valve assembly works using two separate surfaces and a biasing element with a force. When hydrostatic pressure is present forces are created on these surfaces, these forces have a direct relationship with pressure, as an increase in pressure will increase the force and vice versa. The surface areas are designed such that the valve will maintain closed while under a predetermined fluid pressure, indicating to the driller that the inner tube has landed. When the driller relieves the fluid pressure and the pressure decreases, the force difference between the respective forces decreases until the valve opens for drilling through the force from the biasing element.

### FIELD OF THE INVENTION

The present invention generally relates to core barrels. More specifically, it relates to a core barrel head assembly.

### BACKGROUND OF THE INVENTION

It is known in various connections to use valves that control the supply of a fluid by being opened when they are subjected to a certain pressure from the fluid. One such application is in wire line core drilling, as will be described below.

When performing exploratory drilling to collect rock samples from depths of from several hundred to a couple of thousand meters, double core tubes are used having an inner and an outer tube. The sample is collected in the inner tube, which usually has a length of a few meters. When the inner tube is full this is usually detected by means of a manometer or the like that measures the flushing water pressure in the core tube. A retriever device suspended on a wire is lowered into the tube for retracting the inner tube with the sample, said retriever device comprising a gripping means in the form of a claw or “spearhead” arranged to engage with a gripping means arranged on/in the upper end of the inner tube. When the wire is then tautened the inner tube is disengaged from the outer tube, and the inner tube with the sample can be hoisted up. Conversely, the claw and the gripping means on the inner tube can be used to lower a new inner tube. Equipment of this type is generally known as a wire line system.

When a new inner tube is inserted it is important to be able to ascertain that the inner tube really has reached right down to the bottom of the outer tube and has assumed its correct position for drilling, before drilling is commenced. Ascertainment that the tube can no longer move, but is firmly held is generally taken as an indication that the inner tube has reached its correct position. According to known technology, therefore, the gripping means is often designed to be combined with some type of locking member that firmly locks the inner tube in relation to the outer tube when the inner tube has reached the correct position. This locking member usually consists of a hook-like device, preferably spring-loaded, a locking claw or latch that engages with recesses or shoulders arranged in the inside of the outer tube. Actual insertion of the inner tube is usually performed by the inner tube being “pumped” along inside the drill string with the aid of water. When the inner tube is firmly in place the water pressure will increase to such an extent that a valve arranged for flushing medium in the inner tube is released.

One problem with such known arrangements is that when the inner tube is inserted into the drill string it sometimes catches before it has reached the correct position for drilling. With designs currently in use, the increase in water pressure then occurring will release the flushing valve before the inner tube has reached its correct position and, in the worst case, drilling will be commenced. This primarily entails a disadvantage from the financial point of view since the drilling will be into thin air. There is also a risk of the core at the bottom being destroyed. Hence it is useful to provide a landing indicator system in order to ensure that the inner tube has reached its correct position.

The current industry standard to provide a landing indicator system uses a ball and bushing or plunger (ball attached to retracting case) and bushing as a valve assembly with short signal duration.

The current standard for a core barrel valve has a pressure signal that is very short in duration and can be easily missed by the driller and is not reliable on deeper holes and requires frequent replacement. Previously known valves with sustained pressure signals were not reliable due to mud and debris jamming the moving parts of the valve. Previous valves also were limited in hole conditions with a very low water table and very deep holes, as they could not cope with the large differences in hydrostatic pressure.

The system described in U.S. Pat. No. 6,708,784 attempted to remedy some of the above-described problems. U.S. Pat. No. 6,708,784 discloses method for a valve, the valve comprising a movable valve element having a first side facing a means for supplying pressurized fluid and influenced in the supply direction by a force from said fluid, and a second side influenced in opposite direction by a force from said fluid. The valve is provided with at least one connection connecting the first side of the valve element with the second side of the valve element, and also comprises a spring for opening the valve by displacing the valve element from a closed position to an open position. The method comprises the following steps: a pressurized fluid is supplied to the valve in the closed position so that the valve remains closed; the supply of pressurised fluid to the closed valve ceases, a pressure force differential then decreases between the first and second sides thereby enabling the spring to open the valve, and a pressurized fluid is supplied to the valve in the open position and the valve remains open.

However, the valve assembly described in U.S. Pat. No. 6,708,784 is not self-resetting and does not function properly when debris and/or additives are present in the flushing medium.

Consequently, there is still presently a need for a valve assembly for a landing indicator system that is self-resetting and that will work with debris and/or additives in the flushing medium, while functioning properly in low water level conditions and in shallow holes.

### SUMMARY OF THE INVENTION

It is an object of the present invention to provide a valve assembly that addresses at least one of the above-mentioned needs.

Accordingly, the present invention provides a valve assembly for use in a core barrel head assembly positionable within a drill string of a drilling apparatus, the valve assembly comprising:
a landing shoulder;
at least one upstream fluid port positionable within a fluid line of the drilling apparatus upstream of the landing shoulder;
at least one downstream fluid port positionable within the fluid line of the drilling apparatus downstream of the landing shoulder;
at least one fluid pressure communication port positionable within the fluid line of the drilling apparatus upstream of the landing shoulder;
a movable valve element having a first side in fluid communication with pressurized fluid through the at least one upstream fluid port and having a first surface that is influenced in the supply direction by a force from said pressurized fluid, and a second side facing in the opposite direction, in fluid communication with pressurized fluid through the at least one upstream fluid port and having a second surface that is influenced in the opposite direction by a force from said fluid;
wherein the movable valve element is also directly or indirectly influenced in the supply direction by a force from said pressurized fluid through the at least one fluid pressure communication port,
at least one biasing element for opening the valve assembly by displacing the valve element from a closed position to an open position,
   wherein the area of said second surface is greater than that of said first surface so that the force influencing the valve element in a closing direction, in the form of the force from the pressurized fluid acting on said second surface exceeds the force influencing the valve element in an opening direction, in a form of combining a force from the biasing element and the force from the pressurized fluid acting on said first surface and the force, whereby the valve element is retained in the closed position of the valve when pressurized fluid is supplied.

Advantageously, upon a reduction in the supply of pressurized fluid to the closed valve, a pressure force differential decreases between said first and second sides, and the biasing element then urges the valve element to be displaced from said closed position to said open position.

Preferably the valve assembly further comprises at least one locking device for mechanically locking the valve element in said closed position. This eliminates or at least reduces risk of unintentional opening the valve.

It is hereby preferred that the locking device comprises any one from the group: a pin/bolt/stud-slot lock mechanism, a detent or ball lock type mechanism.

The valve element advantageously comprises:
a valve body comprising the second surface; and
a valve piston comprising:
   a piston unit comprising the first surface;
   a valve rod linking the piston unit to the valve body; and
   a pin, bolt or stud attached to piston element and projecting radially, and wherein the locking device comprises:
an upper latch body having a first profiled slot cooperating with the pin, bolt or stud, said first slot comprising a main portion extending along an axial direction and a secondary portion extending in a direction transverse to said axial direction; and
a latch retracting case coaxially displaceable with respect to the upper latch body and overlapping over the upper latch body, the latch retracting case having a second profiled slot or control window cooperating with the pin, bolt or stud, said second slot or control window extending along the axial direction and having a control surface extending in a direction transverse to said axial direction, essentially in parallel to the transverse direction in which the secondary portion of the first slot extends, said latch retracting case cooperating with a latch locking mechanism of the inner tube member, such that the latch retracting case prevents the latch locking mechanism from engaging with latches of the core barrel head assembly upon displacement of the pin, bolt or stud in the secondary portion of the first profiled slot.

According to a preferred embodiment the movable valve element advantageously comprises:
a valve body for co-operation with a valve seat, and
a piston unit being connected to said valve body over a valve rod,
   wherein said first surface is comprised on the piston unit, and wherein said second surface is comprised on the valve body, said first and second surfaces facing each other.

The biasing means is preferably in the form of a spring that is active against said piston unit.

The biasing means is advantageously placed inside a cylinder space which is vented through a bore in the valve rod to a position downstream of the landing shoulder where low pressure prevails in order to avoid resistance against piston movements.

Preferably said piston unit is connected to a locking device over a piston rod which passes through an end wall limiting said cylinder space. Hereby advantageously, said piston rod is arranged to pass sealingly through an opening in said end wall limiting said cylinder space in a closed position of the valve and pass allowing a flushing flow path through said opening in an open position of the valve.

The piston unit is suitably connected to a piston rod, which is connected to said locking device for mechanically locking in said closed position.

Also preferred, the piston unit is controlled by a latch retracting case, which is connected to a spearhead for retrieval.

The piston unit is in a preferred variant comprised of a top piston and a bottom piston, which are separable, wherein said first surface is comprised on said bottom piston of the piston unit. Preferably, said top piston and said bottom piston are each provided with an individual locking device for mechanically locking in said closed position.

The valve body and the piston unit are preferably parts of an integral unit in one piece.

Further, advantageously the valve element comprises:
a valve body comprising the second surface; and
a valve piston comprising:
   a piston unit comprising the first surface;
   a valve rod linking the piston unit to the valve body; and
   a pin, bolt or a stud attached to piston element and projecting radially,
      wherein the locking device or devices comprise (-s):
an upper latch body having a first profiled slot cooperating with the pin, bolt or stud, said first slot comprising a main portion extending along an axial direction and a secondary portion extending in a peripheral direction being oblique to said axial direction; and
a latch retracting case coaxially displaceable with respect to the upper latch body and overlapping over the upper latch body, the latch retracting case having a control window cooperating with the pin, bolt or stud, said control window extending along the axial direction and having a control edge extending in a peripheral direction being oblique to said axial direction, preferably essentially parallel to the peripheral direction in which the secondary portion of the first slot extends, said latch retracting case cooperating with a latch locking mechanism of the inner tube member, such that the latch retracting case prevents the latch locking mechanism from engaging with latches of the core barrel head assembly upon displacement of the pin, bolt or stud with the control surface,
   and wherein a step of causing the locking device to cease locking the valve element in the closed position further comprises a step of displacing the pin, bolt or stud in said peripheral direction from the secondary portion to the main portion of the first profiled slot, upon proper deployment of the latch locking mechanism, thereby allowing axial movement of the piston unit.

In a valuable variant, the movable valve element is comprised of one or more pieces.

Preferably a space for containing the biasing means is vented to a low pressure space, in particular downstream of the landing shoulder.

A latch rod is preferably arranged to prevent the valve from opening in case latches are not in an extended position to avoid failure. Preferably, the latch rod is coupled to the piston unit.

The invention also relates to a method for operating a valve assembly for use in a core barrel head assembly positionable within a drill string of a drilling apparatus driven by pressurized fluid, the valve assembly comprising:
a landing shoulder;
at least one upstream fluid port positionable within a fluid line of the drilling apparatus upstream of the landing shoulder;
at least one downstream fluid port positionable within the fluid line of the drilling apparatus downstream of the landing shoulder;
at least one fluid pressure communication port positionable within the fluid line of the drilling apparatus upstream of the landing shoulder;
a movable valve element having a first side in fluid communication with pressurized fluid through the at least one upstream fluid port and having a first surface that is influenced in the supply direction by a force from said pressurized fluid, and a second side facing in the opposite direction, in fluid communication with pressurized fluid through the at least one upstream fluid port and having a second surface that is influenced in the opposite direction by a force from said fluid;
wherein the movable valve element is also directly or indirectly influenced in the supply direction by a force from said pressurized fluid through the at least one fluid pressure communication port,
at least one biasing element for opening the valve assembly by displacing the valve element from a closed position to an open position,
   wherein the area of said second surface is greater than that of said first surface so that the force influencing the valve element in a closing direction, in the form of the force from the pressurized fluid acting on said second surface exceeds the force influencing the valve element in an opening direction, in a form of combining a force from the biasing element and the force from the pressurized fluid acting on said first surface and the force from said pressurized fluid through the at least one fluid pressure communication port, whereby the valve element is retained in the closed position of the valve when pressurized fluid is supplied,
   the method comprising the steps of:
supplying the pressurized fluid to the valve element in said closed position whereupon the valve assembly remains closed;
reducing the supply of pressurized fluid to the closed valve assembly; and
allowing a pressure force differential to decrease between said first and second sides, thereby enabling the biasing element to urge the valve element towards the open position, and thereby allowing fluid flow through the at least one upstream fluid port.

Preferably the valve assembly further comprises a locking device for mechanically locking the valve element in said closed position, wherein, in step a), the valve element is in a mechanically locked closed position, and further comprising the step, between steps a) and b) of:

i) causing the locking device to cease locking the valve element in the closed position.

Step i) preferably further comprises the step of allowing fluid pressure to engage a latch lock of the latch locking mechanism.

The method further includes the step of causing the locking device to cease locking the valve element in the closed position further comprises a step of displacing the pin, bolt or stud in said peripheral direction from the secondary portion to the main portion of the first profiled slot, upon proper deployment of the latch locking mechanism, thereby allowing axial movement of the piston unit.

In accordance with the present invention, there is also provided wire line core drill system comprising a wire line core drill having an inner tube by means of which core samples are collected, an outer tube connected to a drill bit, and a valve assembly situated at the rear end of the inner tube, the valve assembly controlling the supply of a flushing medium in the form of a pressurized fluid, wherein the valve assembly is constructed as described above.

The valve assembly according to the present invention provides two separate ports upstream of the landing shoulder and allowing fluid pressure to apply a force on two different surfaces eliminating small fluid passages that are prone to blockage from debris and allowing for significantly less restricted flow for drilling when the valve is open. Fluid pressure can be required to lock the latches engaged in the drill string. This ensures that the valve assembly will remain closed when the head has landed but fluid pressure has not yet built up. This feature also greatly decreases the pressure applied by the latches to the inside wall of the drill string while it is travelling down the drill string, greatly reducing the friction, decreasing wear on the latches and decreasing the time to travel to the bottom of the hole. The valve assembly can thus function in low water level conditions and in shallow holes.

The valve assembly according to certain embodiments of the present invention can also be self-resetting, a feature not present in the system described in U.S. Pat. No. 6,708,784. The system described in U.S. Pat. No. 6,705,784 would also not function properly when debris was present between sliding surfaces of the valves. However, the valve assembly according to the present also provides a reduced sliding surface area with seals added to block debris from entering these areas.

### BRIEF DESCRIPTION OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is an exploded view of a head assembly, with interchangeable mid latch bodies.

FIGS. 2A to 2C are cross-sectional side views of a head assembly according to another embodiment.

FIGS. 3A to 3C are detailed cross-sectional side views of the head assembly corresponding to the views shown in FIGS. 2A to 2C, illustrating flow streamlines through the valve assembly.

FIGS. 4A to 4D are partial detailed cross-sectional side views of the head assembly with a valve assembly according to another embodiment, illustrating a sequential use of the valve assembly.

FIGS. 5A and 5B are partial side views of an upper latch body and latch retracting case of the head assembly shown in FIGS. 2A to 2C.

FIGS. 6A and 6B are a partial cross-sectional view of a valve assembly and partial side view of a joined upper latch body and latch retracting case, respectively, of the head assembly shown in FIGS. 2A to 2C, during a descent phase of a sequential use of the valve assembly.

FIGS. 7A and 7B are a partial cross-sectional view of a valve assembly and partial side view of a joined upper latch body and latch retracting case, respectively, of the head assembly shown in FIGS. 2A to 2C, during a signal phase of a preferred sequential use of the valve assembly.

FIGS. 8A and 8B are a partial cross-sectional view of a valve assembly and partial side view of a joined upper latch body and latch retracting case, respectively, of the head assembly shown in FIGS. 2A to 2C, during a working phase of a sequential use of the valve assembly.

FIGS. 9A and 9B are a partial cross-sectional view of a valve assembly and partial side view of a joined upper latch body and latch retracting case, respectively, of the head assembly shown in FIGS. 2A to 2C, during a transition to the retracting/retrieval phase of a preferred sequential use of the valve assembly.

FIGS. 10A and 10B are a partial cross-sectional view of a valve assembly and partial side view of a joined upper latch body and latch retracting case, respectively, of the head assembly shown in FIGS. 2A to 2C, during a retracting/retrieval phase of a sequential use of the valve assembly.

FIG. 11A to 11D are cross-sectional views of an embodiment of a valve assembly according to the invention, during a descent phase, a high pressure phase, an open operation phase and a retracting/retrieval phase.

FIGS. 11a to 11d are side views of the valve assembly according to FIGS. 11A to 11D.

FIGS. 12A to 12D are cross-sectional views of another embodiment of a valve assembly according to the invention, during a descent phase, a high pressure phase, an open operation phase and a retracting/retrieval phase.

FIGS. 13A to 13D are side views of the valve assembly according to FIGS. 12A to 12D.

FIG. 14A to 14D are cross-sectional views of a further embodiment of a valve assembly according to the invention, during a descent phase, a high pressure phase, an open operation phase and a retracting/retrieval phase.

FIGS. 14a to 14d are side views of the valve assembly according to FIGS. 14A to 14D.

### PREFERRED EMBODIMENTS OF THE PRESENT INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings and are thus intended to include direct connections between two members without any other members interposed therebetween and indirect connections between members in which one or more other members are interposed therebetween. Further, “connected” and “coupled” are not restricted to physical or mechanical connections or couplings. Additionally, the words “lower”, “upper”, “upward”, “down” and “downward” designate directions in the drawings to which reference is made. The terminology includes the words specifically mentioned above, derivatives thereof, and words or similar import.

In this description and drawings, elements in one embodiment are exchangeable to similar, corresponding or equivalent elements in the other embodiments. One example of this is “second profiled slot” which can be exchanged for “control window”.

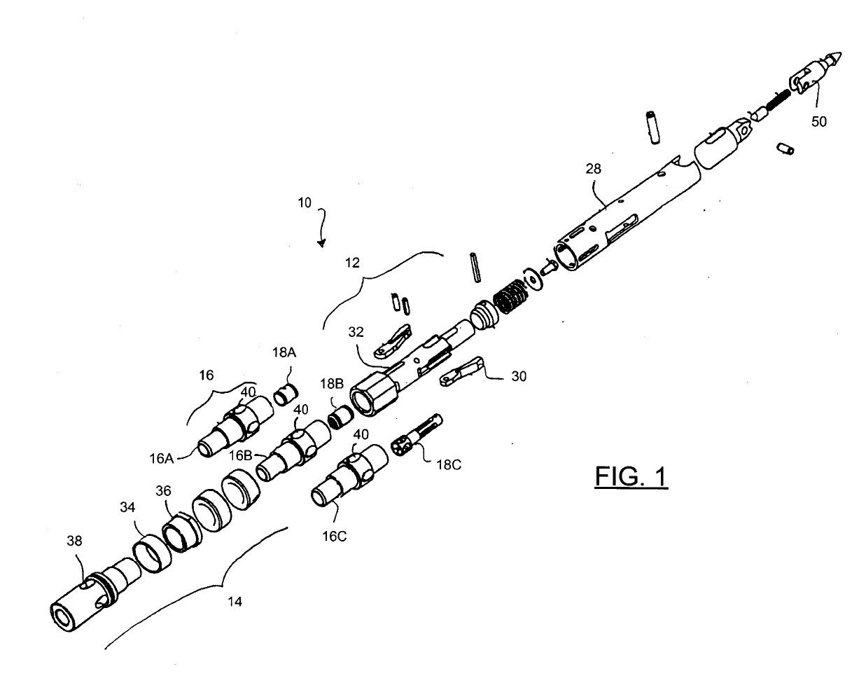

Referring now to the drawings in detail, wherein like numbers are used to indicate like elements throughout, there is shown in FIG. 1 an exploded view of a presently preferred embodiment of an core barrel head assembly 10 for a drilling apparatus.

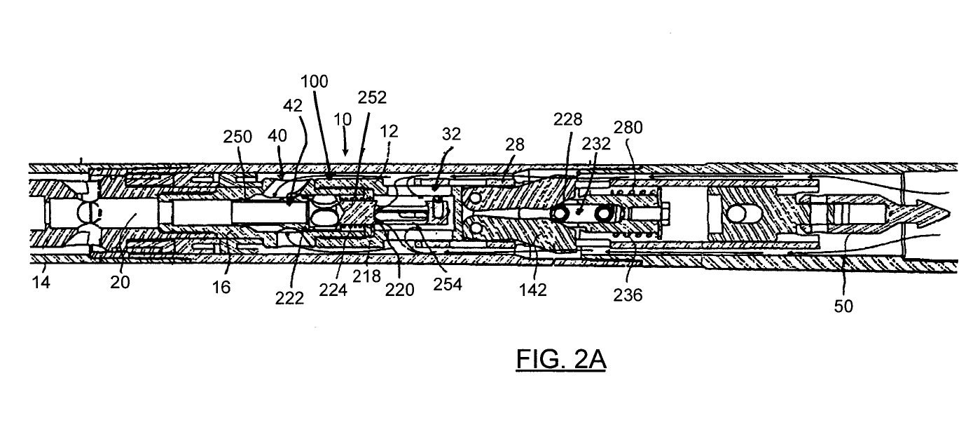

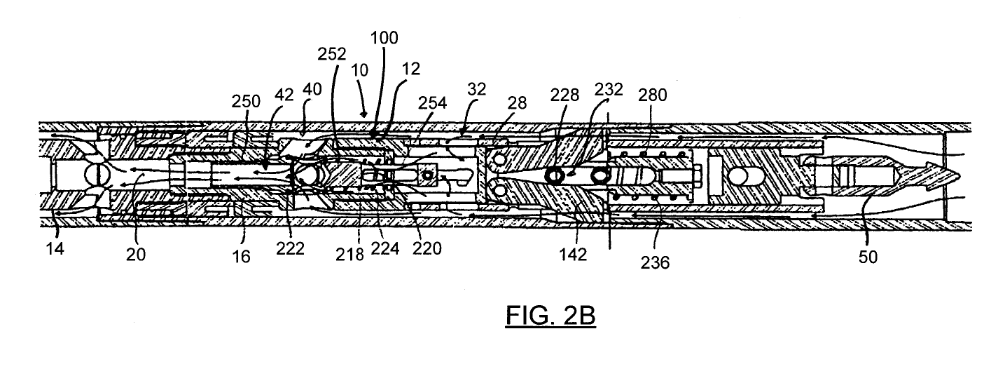

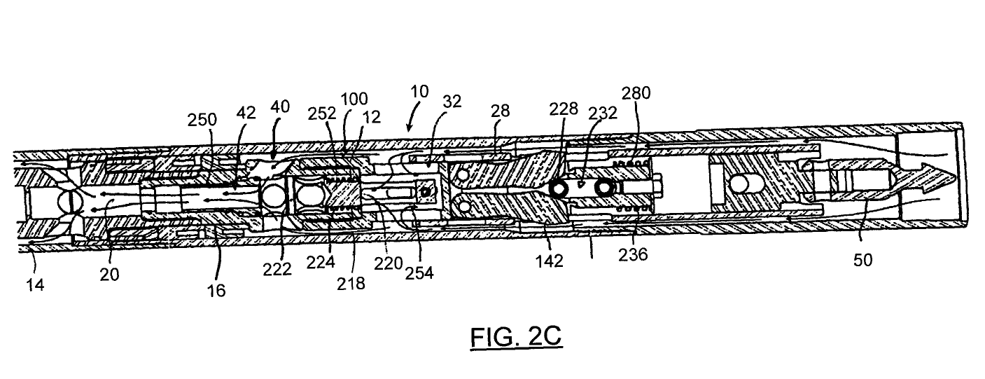

The core barrel head assembly 10 is positionable within a drill string of a drilling apparatus. The core barrel head assembly 10 comprises an upper latch body 12 and a lower latch body 14. The head assembly 10 further comprises a mid latch body 16 separating the upper latch body 12 from the lower latch body 14 and removably coupling the upper latch body 12 to the lower latch body 14. FIG. 1 shows three different sample embodiments of the mid latch body 16A, 16B, 16C to illustrate the interchangeability of the mid latch body 16. In all cases, the mid latch body 16 is removably coupled to the upper latch body 12 and the lower latch body 14. The mid latch body 16 houses a landing indicator device 18. A common central bore 20 is formed by the upper latch body 12, the lower latch body 14 and the mid latch body 16 (see FIG. 2A to C).

Preferably, as illustrated in FIG. 1, the head assembly includes an upper latch body 12 with a latching assembly 30 and fluid pressure communication ports 32. The lower latch body 14 holds a landing shoulder 34 by a removable sleeve 36 and includes fluid flow ports 38 downstream of the landing shoulder. The mid latch body component 16 also has fluid flow ports 40 upstream of the landing shoulder, and connects the upper and lower latch bodies, 12,14, with a central bore 20 connecting the fluid flow ports 38,40. The mid latch body 16 contains a valving mechanism 42 which can provide a landing indication signal (see FIG. 2A to C). The common central bore 20 is present through all body components. The head assembly preferably includes of two sets of ports: the first set for fluid pressure communication with the internal valving mechanism 42, the second set for fluid flow required for drilling in which the fluid flow is blocked or opened by the internal valving mechanism 42. This fluid port design offers the advantages of increased fluid flow during drilling which means it is less likely to collect debris and pack with mud and thus results also in a more efficient pumping system, compared to a head assembly where all the fluid circulates through a single port system upstream of the landing shoulder (thus more subject to blockage) from the upper latch body to the lower latch body, with no bypass port. Given the reconfigurable nature of the head assembly, different valving systems can be used depending on drilling conditions and also can be easily upgraded when a newer type of valve is developed. FIG. 1 illustrates an example of three different head assemblies in which the upper 12 and lower 14 latch bodies are similar and could be shared, but where a changeout of the mid latch body 16 allows the use of different valving mechanism designs that can be tailored to a specific drilling condition.

The following sections will illustrate different valving mechanisms that can be changed out through different mid latch bodies 16 while also benefiting from the advantages of having the distinct fluid pressure communication ports 32 and fluid flow ports 40 upstream of the landing shoulder.

### Fluid Controlled Valves

FIG. 2A-10B show different embodiments of a head assembly in accordance with another preferred embodiment of the present invention. Once again, the head assembly allows for an interchangeable mid latch body 16 between an upper latch body 12 and a lower latch body 14. Also, the valving assembly in the mid latch body benefits from the use of separate pressure communication ports 32 and fluid flow ports 40. The head assembly includes a valve assembly 100 for use in a core barrel head assembly 10 positionable within a drill string of a drilling apparatus. The valve assembly 100 comprises at least one pressure port 32 formed in a sidewall of the core barrel head assembly 100 upstream of the landing shoulder. There is also at least one fluid flow port 40 formed in the sidewall of the core barrel head assembly 100 upstream of the landing shoulder. The valve assembly 100 also includes a movable valve element 218 having a first side 220 in fluid communication with pressurized fluid through the head assembly and having a first surface that is influenced in the supply direction by a force F_{A} from said fluid. A second side 222 faces in the opposite direction, in fluid communication with the pressurized fluid through the head assembly and having a second surface that is influenced in the opposite direction by a force F_{B} from the fluid. A biasing element, such as a spring 224 or any equivalent resilient element is provided for urging the valve assembly towards an opened configuration by displacing the valve element 218 from a closed position, blocking the at least one fluid flow port 40, to an open position. The biasing element or spring may be designed to be adjustable

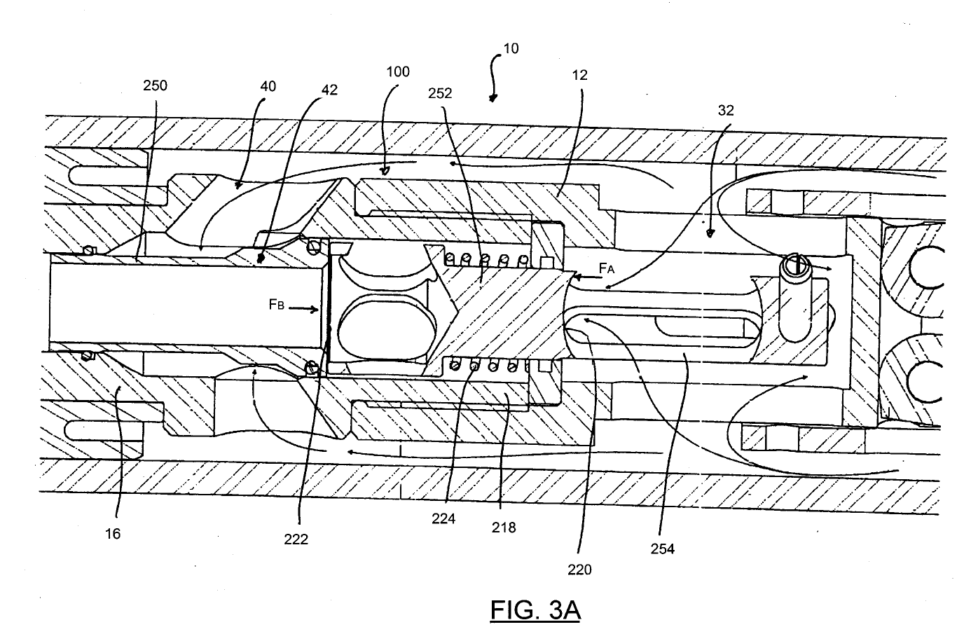

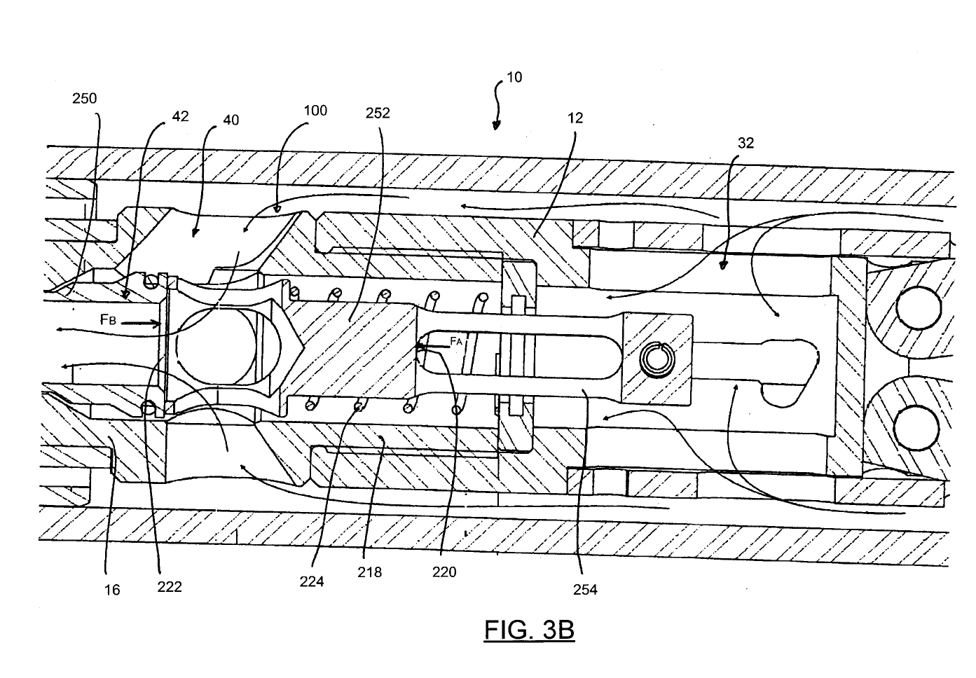

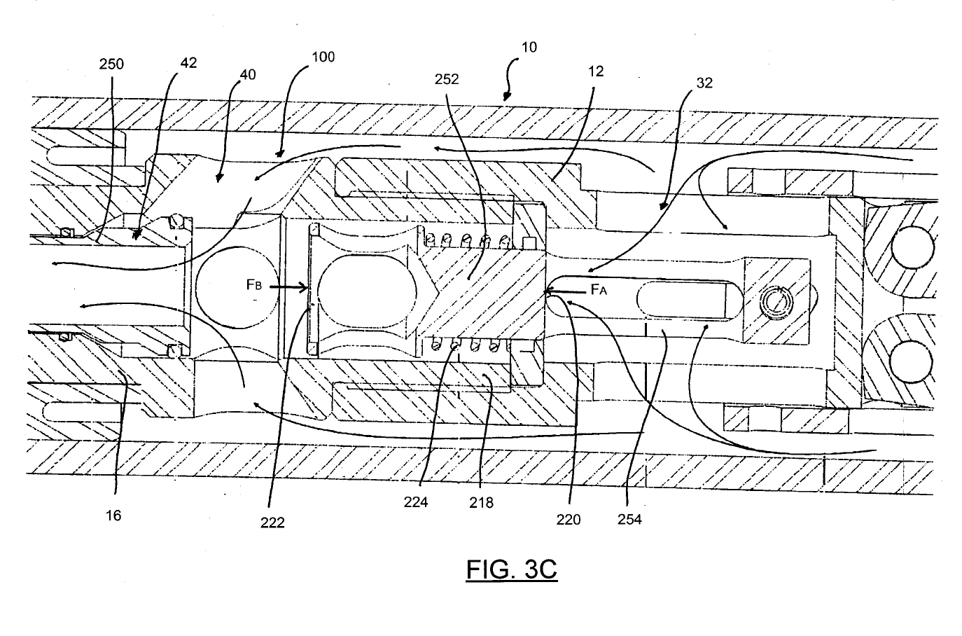

The area of the second surface is greater than that of the first surface so that the force influencing the valve element 218 in a closing direction, in the form of the force F_{B} from the pressurized fluid acting on the second surface exceeds the force influencing the valve element in an opening direction, in the form of the combined force Fs from the spring and the force F_{A} from the pressurized fluid acting on the first surface, whereby the valve element is retained in the closed position of the valve when pressurized fluid is supplied, as illustrated in FIGS. 2A and 3A

Preferably, upon a reduction in the supply of pressurized fluid to the closed valve, the pressure force differential decreases between said first and second sides 220,222, and the spring 224 then urges the valve element 218 to be displaced from its closed position to its open position unblocking the at least one fluid flow port 40 as shown in FIGS. 2B and 3B.

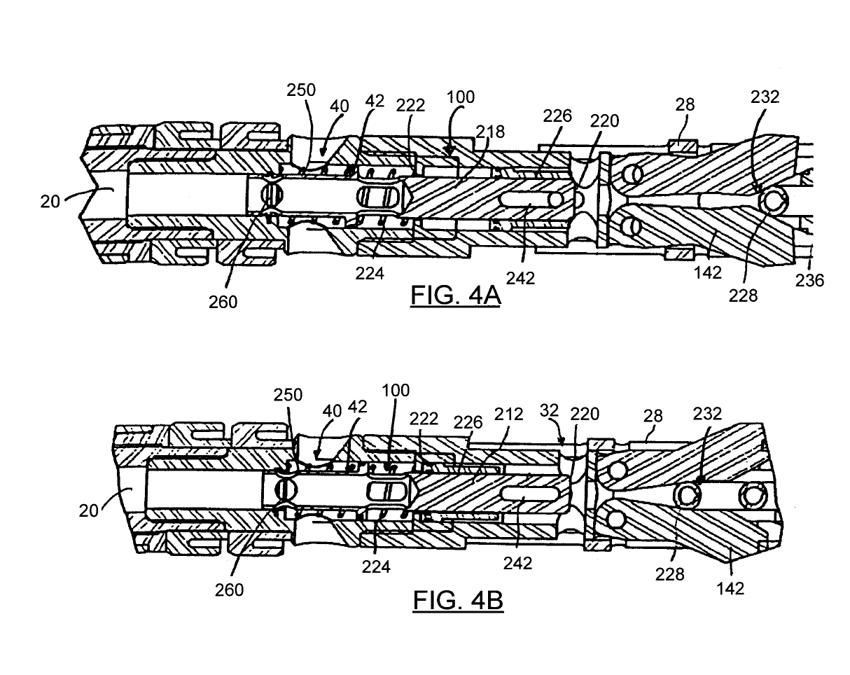

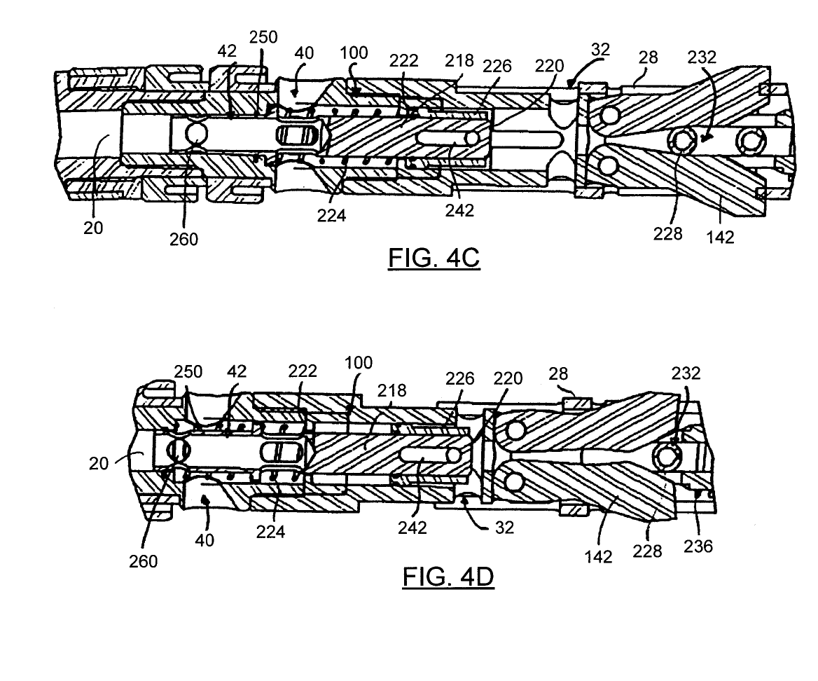

Preferably, the valve assembly further comprises a locking device for mechanically locking the valve element in its closed position. In one possible embodiment illustrated in FIG. 4A to 4D, the locking device comprises a pressure sleeve 226 mechanically connected through the retracting case 28 to a latch locking mechanism 232 of the inner tube member. Another possible embodiment of the locking device is illustrated in FIG. 2A to 3C and FIG. 5A-10B and will be described in further detail below.

There is also provided a method for operating the valve assembly for use in a core barrel head assembly positionable within a drill string of a drilling apparatus driven by pressurized fluid, the

method comprising the steps of:
supplying the pressurized fluid to the valve element 218 in its closed position whereupon the valve assembly remains closed;
reducing the supply of pressurized fluid to the closed valve assembly; and
allowing a pressure force differential to decrease between the first and second sides 220,222, thereby enabling the biasing means 224 to urge the valve element 18 towards the open position, and thereby allowing fluid flow through the at least one fluid flow port and remain open.

When the valve assembly 100 further comprises a locking device for mechanically locking the valve element in its closed position, in step a), the valve element is in a mechanically locked closed position, and the method further comprises the step, between steps a) and b) of:

i) causing the locking device to cease locking the valve element 218 in the closed position.

The locking device may comprise a pressure sleeve 226 mechanically connected to a latch locking mechanism 232 of the head assembly and step i) further comprises the step of allowing fluid pressure to displace the pressure sleeve 226 and engage a latch lock 228 of the latch locking mechanism 232.

As mentioned above, another embodiment of the fluid controlled valve assembly, and in particular the locking device, illustrated in FIG. 2A-3C and 5A-10B, will now be presented. Preferably, the valve element is a two-piece valve comprising a valve body 250 and a valve piston 252. The valve body 250 is used to selectively block the fluid flow port 40 and includes a side 222 which applies a force to urge the valve assembly towards a closed configuration. The valve piston 252 includes a side 220 which applies a force to urge the valve assembly towards an open configuration, The valve piston 252 further comprises a slotted stem 254 to allow fluid flow to flush debris and a pin 256 to co-operate with the profiled slots in the upper latch body 12 and latch retracting case 28 to be able to selectively lock the valve assembly in a closed configuration.

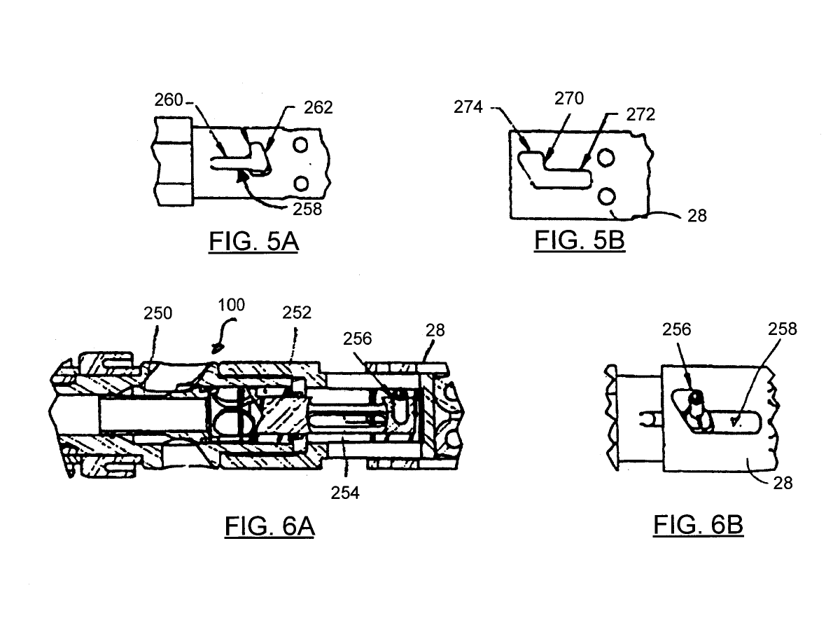

As better shown in FIG. 5A the upper latch body 12 comprises a profiled slot 258 to co-operate with the pin 256 of the valve piston 252 to lock the valve-in the closed position and allow the valve to move to the open position after a predetermined rise in fluid pressure. More specifically, the profiled slot 258 allows axial movement of the pin within the main slot portion 260. A top end 262 of the slot 258 extends at an angle transversely with respect to the main slot portion, at least partially radially and towards the opposite bottom end to prevent the pin 256 from moving downward. The pin 256 is held in the radially extended slot position by the spring 224 that biases the valve assembly towards the open position.

As the fluid pressure rises and the force on the surface of side 220 overcomes the spring force, both valve body 250 and piston 252 will move up and the pin 256 on the valve piston 252 will be directed by the angled slot extension 262 to move the pin 256 radially (or rotate it) towards the main slot portion 260 to allow for axial movement of the pin and hence the valve member when the pressure is released.

As shown in FIG. 5B, the latch retracting case 28 also has a profiled slot 270 to cooperate with the pin 256 on the valve piston 252. The latch retracting case 28 automatically moves the pin 256 to the locked position on the profiled slot 258 of the upper latch body 12 when the latches 142 are retracted. The profiled slot thus helps to hold the latch retracting case 28 and latch lock in an intermediate up position such that the latch lock is not engaged to the latches 142, greatly reducing the latch drag on the drill rod during descent.

The profiled slot 270 allows for axial movement of the pin 256 within a main slot portion 272. A bottom end 274 of the slot extends at an angle with respect to the main slot portion 272, at least partially radially and axially lower than the main slot portion 272, thus rotating the pin 256 towards the locked position in the upper latch body 12 when the latch retracting case 28 is moved up to retract the latches 142. The pin 256 during the latch retraction can then extend back towards the bottom end 274 in a direction parallel to the main slot.

When released from the overshot and during descent, the biaising means 280, such as a spring or other equivalent resilient element, in the retracting case 28 will bias the retracting case 28 towards the down position. The bottom end portion 274 of the profiled slot 270 will prevent the retracting case 28 from moving to the fully down position as it is being held in an intermediate up position, preventing the latch lock from engaging with the latches 142, once again greatly reducing the latch drag on the drill rod during descent.

An operational sequence of the valve assembly will now be described. Reference will be made to components illustrated in the two different groups of embodiments illustrated respectively in FIG. 2A to 3C/5A to 10B and FIG. 4A to 4D.

### Descent

Before inserting the inner tube head assembly in the drill string, the latch retracting case 28 is pulled up (right side in FIGS. 2A, 4A or 6A) to its first position. This will disengage the latch lock 228 and allow the latches 142 to move freely from the engaged position to the retracted position and vice versa. The valve biasing means 224 and retracting case biasing means 236 are compressed. In the embodiment shown in FIG. 4A, the latch retracting case 28 is directly connected to the pressure sleeve 226. The pressure sleeve 226 and/or the latch retracting case 28 are held in this first position (with a mechanical lock) as it is travelling through the drill string, to reduce the latch drag on the drill rod during descent. In the embodiment shown in FIG. 2A or 6A-6B, the pin 256 attached to the valve piston 252 is constrained through interaction with profiled slots 258, 270 and thus prevented from moving down to lock the latches 142, thereby reducing latch drag on the drill rod. The valve body 250 blocks fluid flow through the fluid flow port 40.

### Signal

When the head assembly 10 has landed in the correct position, for the embodiment shown in FIG. 4B, fluid pressure will increase and act on the surface 220 and push with a force at a first predetermined value less than a second predetermined value, such as for example, maximum pump pressure, to move the pressure sleeve 226 down and engage the latch lock 228 with which it is directly connected through the latch retracting case 28. In this configuration, the latches 142 are engaged and locked into the outer tube and the valve element 218, which is connected to the retracting case 28 by slot 242 is allowed to operate normally. If the latches 142 are not in the correct position, the latch lock 228 and its directly connected components will not be able to move down to the second position and allow the valve to operate normally. Fluid pressure will remain high even after it has been released to the atmosphere, indicating to the driller that the latches are not properly engaged and corrective action must be taken. In the second position, the fluid pressure continues to rise and acts on first surface 220 through pressure communication port 32 and second surface 222 through fluid flow port 38. The first surface area is smaller than the second surface area such that when fluid pressure is present, the force generated by the second surface area is greater than the combined force generated by the first surface area and the force of the spring 224. This will maintain the valve in the closed position while fluid pressure is acting on the valve.

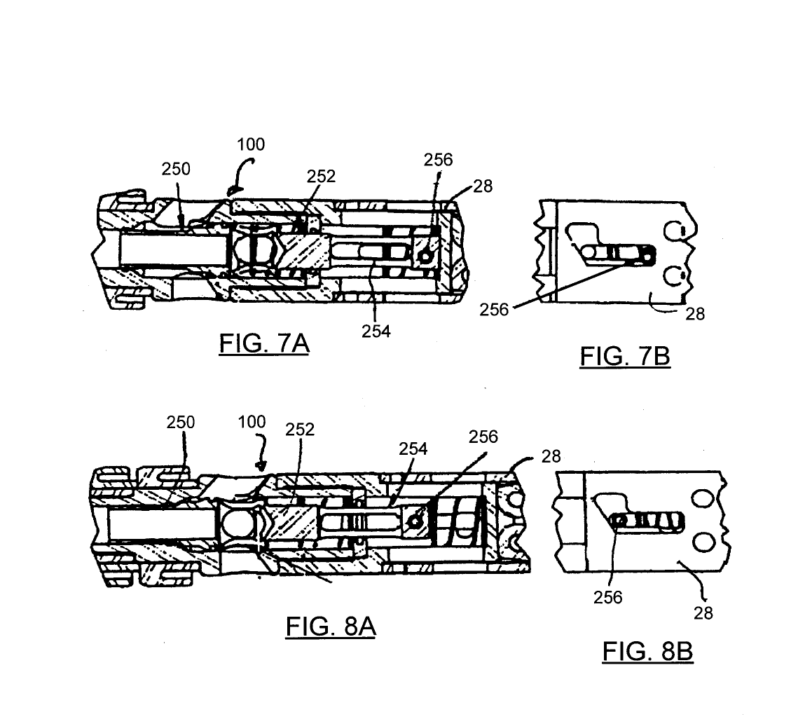

For the embodiment shown in FIG. 7A-7B, under similar fluid pressure conditions, the increased pressure will displace the valve body 250 and valve piston 252 up, which through interaction with the profiled slots 258,260, induces rotation of the pin 256 out of its locked configuration. This permits the valve piston 252 to move and allows the retracting case 28 to descend while the latches 142 become engaged. However, if the latches 142 are jammed, the retracting case 28 will not move down, thus blocking movement of the valve piston 252 and valve assembly and preventing opening of the fluid flow port 40.

### Working

For the embodiment shown in FIG. 4C, when the fluid pump is stopped and the pressure is relieved, a pressure force differential decreases between the first and second surfaces 220,222 so that the biasing means 224 or spring force will move the valve element 218 down to an open, third position. The pump will then be turned back on and drilling fluid will flow freely through fluid flow port 40 to the drill bit for drilling.

For the embodiment shown in FIGS. 2B and 8A, 8B, once fluid pressure is relieved, the biasing means 224 or spring force also overcomes the pressure force differential between the first and second surfaces 220,222 to urge the valve element 218 towards an open position. In this configuration, fluid flows through the slots in the valve piston 254 and through the valve body 250 into the central bore 20.

### Retracting/Retrieval

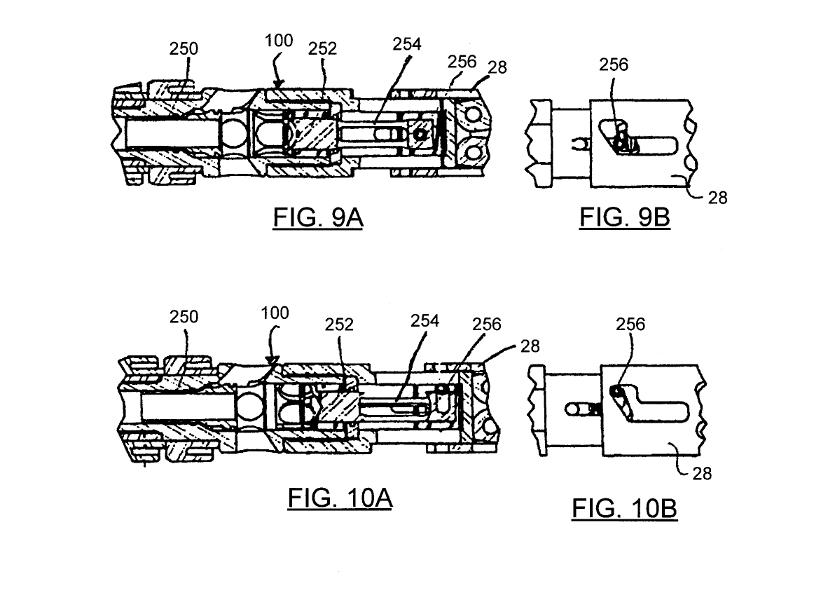

When the inner tube is full of core, the retrieval device or overshot is sent down the drill string and connects to the spearhead 50. For the embodiment shown in FIG. 4D, the spearhead 50, which is connected to the retracting case 28 is pulled up for retrieval and moves the retracting case 28 up past the first position it had during descent to its fourth position. The valve element 218 and valve body 250, being slideably connected to the retracting case 28, is moved up past the first position as well to allow fluid to flow through the apertures 260. When the overshot is disconnected from the spearhead 50, the spring 236 will return the valve assembly to the first descent position and it will be ready for the next trip down the hole. For the embodiment shown in FIGS. 2C and 9A-9B, under similar conditions, retraction of the retracting case 28, induces rotation of the pin 256 towards a locked configuration thus keeping the latches 142 in an unlatched configuration and minimize drag of the latches on the drill rod during retrieval of the spearhead 50. This configuration also positions the valve body 250 in a configuration which keeps the fluid flow port 40 open during the retrieval operation.

### Reset

For the embodiment shown in FIG. 10A-10B, once the valve assembly is returned to the surface, the valve body 150 must be displaced manually at the surface location in order to position the valve body 150 in a closed configuration that will be ready once again for the next descent down the hole. For the embodiment shown in FIGS. 4A-4D, the reset can be done automatically.

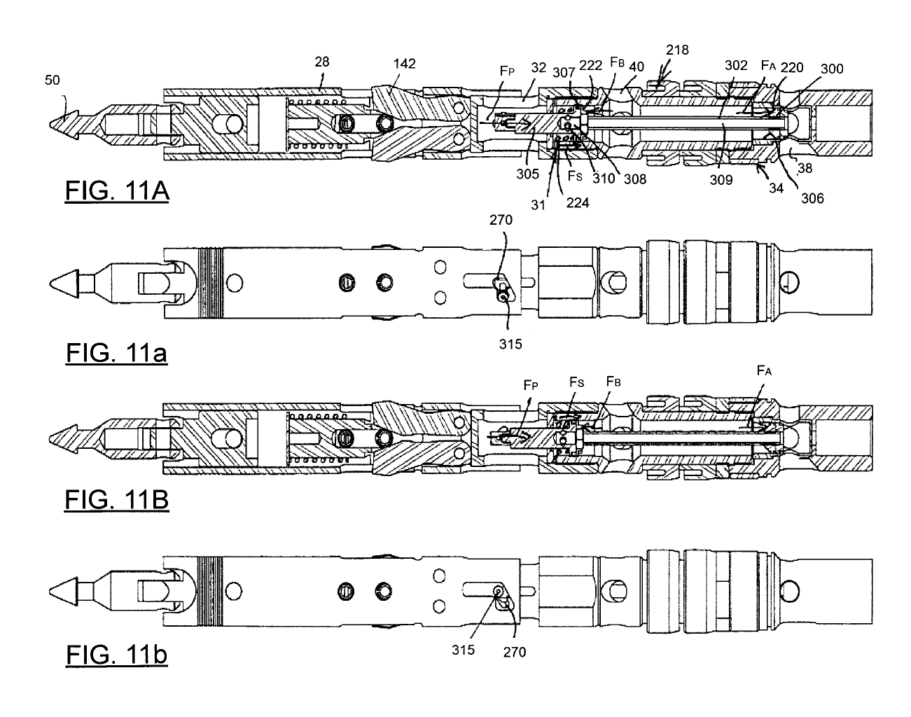

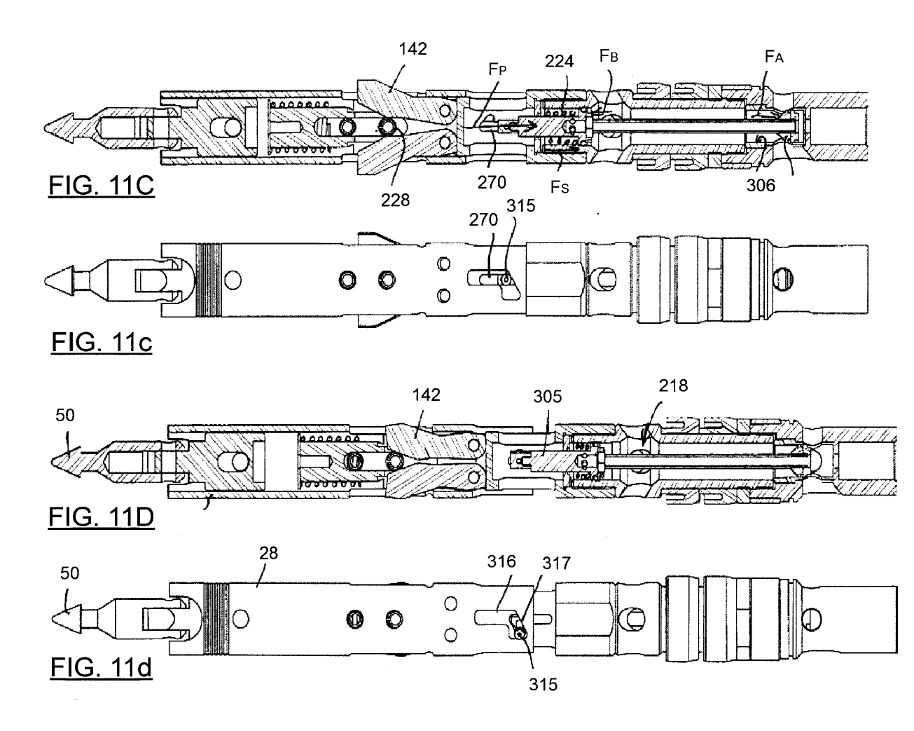

The inventive core barrel head assembly 10 in FIGS. 11A-D and 11a-d differs from the one described above i.a. in that it comprises a differently constructed movable valve element 218 wherein surfaces on a first side 220 and a second side 222 are facing against each other instead of, according to the above described embodiment, they are facing away from each other. The movable valve element 218 according to FIGS. 11A-D and 11a-d thus comprises a valve body 300 for co-operation with a valve seat 306 being in the form of an axially directed bore. The valve body 300 is connected to a valve rod 302, which on its other side, the opposite side being closest to the drilling machine, is connected to a piston unit 307. On its side opposite to the valve body 300, the piston unit 307 limits a cylinder space 311 which is also containing the biasing means 224 such as a spring.

On its side opposite to the valve rod 302, the piston unit 307 is connected to a piston rod 305 which sealingly passes through an opening in an upper wall limiting the cylinder space 311 and supports, at its end being most distal from the piston unit 307, a pin (not shown) for the cooperation with a profiled slot together forming a locking device essentially in correspondence with what has been described above.

The cylinder space 311 is vented over one or more openings 310 in the piston rod 305 and through a top bore 308 which is extending axially inside the piston rod 305 and contacts a bottom bore 309 inside the valve rod 302. The bottom bore 309 opens into a low pressure space downstream of the valve body 300 and thus, connects the cylinder space 311 with a space essentially inside downstream fluid ports 38. Hereby the movable valve element 218 of the embodiment in FIGS. 11A-D and 11a-d basically works in the same way as is described above and is actuated by the fluid pressure prevailing in a space 313 between the first and second sides 220 and 222 and by a force actuating the piston rod from fluid pressure prevailing inside fluid pressure communication port (-s) 32.

Before the descent phase, when the core barrel head assembly is pumped down inside the drill string, the locking device is put into its locked position whereby the valve is closed and the valve body 300 seats in the valve seat 306. This is illustrated in FIGS. 11A and 11a. Further, in FIG. 11a is shown a profiled slot 270, wherein a pin 315 being associated with the piston rod 305 is in its locked position.

When the core barrel head assembly 10 has reached an end of the drill string and the landing shoulder 34 has seated on the corresponding shoulder inside the drill string (not shown), the pressure in the flushing fluid flow will increase as will the pressure inside the space 313. Hereby the forces acting on the respective first and second sides of the valve element 218 will increase until the force F_{B} acting on the second side will be greater than the sum of the force F_{A} from pressure fluid acting on the first side 220 and the force from the biasing means 224 and an additional force resulting from fluid pressure influencing the piston rod, since the area of the surface on the first side is exceeds the area of the surface on the second side. Hereby the movable valve element 218 will move to the left, as seen in FIGS. 11B and 11b and be rotated as is described above by the said pin reaching the axially extending part of the profiled slot.

It should be noted, that also the area of the piston rod, being subject to pressure entering through the fluid pressure communication port 32 has to be considered when dimensioning the surface areas to be actuated by pressure. A force from pressurized fluid acting on the piston rod is indicated: Fₚ. This force acts in the same direction as the forces F_{A} and F. The force balance as described above thus has to be completed with Fₚ for this and the following embodiments to be complete:

Force acting in valve closing direction: F_{B}
Forces acting in valve opening direction: F_{A}, F_{S}, F_{P}

Hereafter, when the pressure is released, the forces on the first and the second sides will be equalized and the force from the biasing means 224 will press the movable valve element 218 to an open position, leaving the valve seat 306 open so that flushing fluid can flow through the upstream fluid port 40 through the space 313 and out through the downstream fluid port 38 on the way to the drill bit whereupon drilling can be started. The pin 315 has reached a far end to the right, as seen in the Figures, in the axially extending portion of the respective profiled slots. Simultaneously, a latch lock 228 has entered between latches 142 in order to secure them in the engagement position. This is illustrated in FIGS. 11C and 11c.

In FIGS. 11D and 11d the assembly is shown during the retrieval phase, whereby a force is applied to the spear head 50, whereby the retracting case 28 is moved relatively upwardly, to the left, as seen in the Figures, whereupon the piston, and the piston rod 305 are moved so as to reset the locking device into locked position and pre-strain the spring being the biasing means 224. At the same time, the latch lock disengages the latches 142 and the latches are brought inwardly in similarity to what is explained above. The movable valve element 218 follows the movement of the piston and reaches a closed position. This prevents fluid present in the drill string to flow through the respective upstream and downstream fluid ports 40 and 38, respectively during the retrieval phase.

It is not excluded to disconnect the retracting case 28 from the piston. This would have the advantage that water being present above the core barrel head assembly did not have to be lifted during this phase. Subsequently reset of the piston and the movable valve element 218 into closed position could in such a case be made manually outside the drill string or automatically through pressing a release mechanism to initiate a spring to move the movable valve element to the locked position.

In FIG. 11d is shown a second profiled slot or “control window” 316 in the retracting case 28 which over an oblique surface 317 cooperates with the pin 315 to position it in its locked position in the oblique portion of the profiled slot 270. This function basically as is explained above in relation to the first described embodiment.

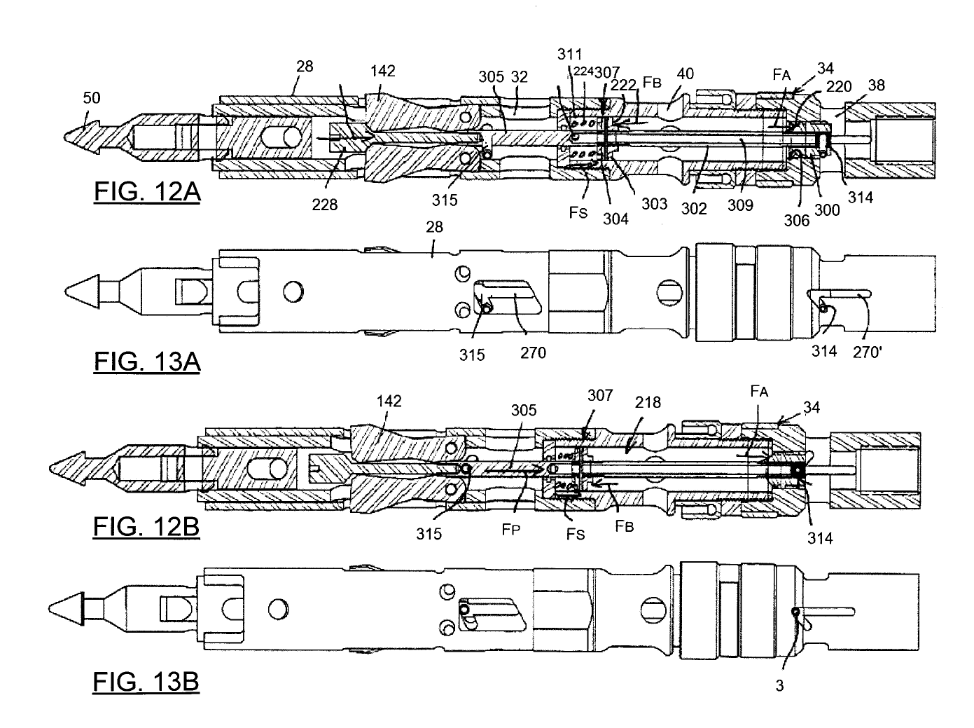

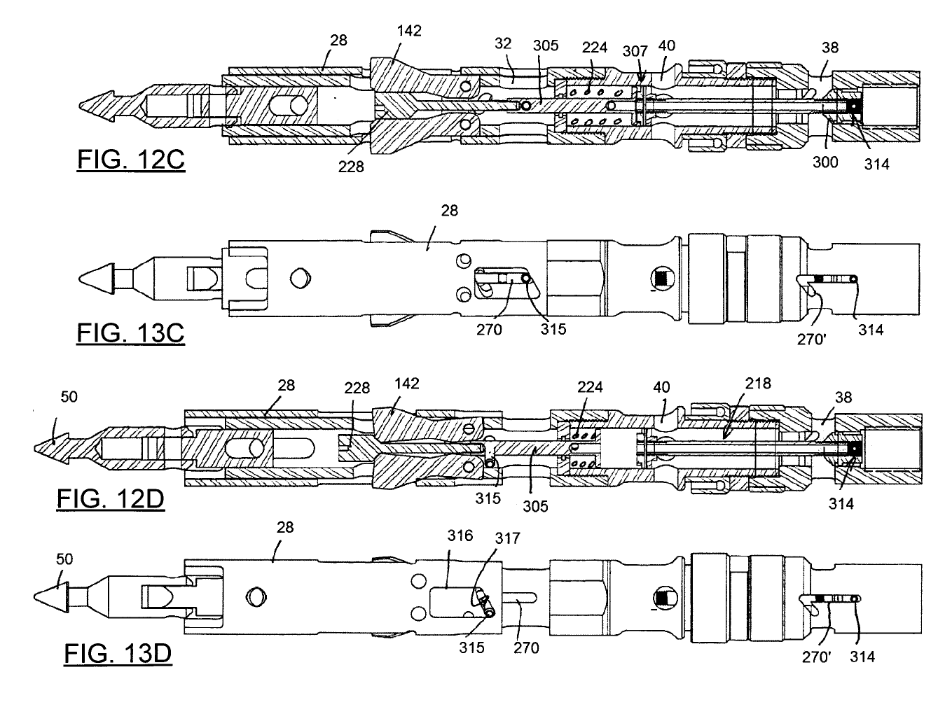

In this inventive embodiment and in the one described in conjunction with FIGS. 12A-D and 13A-D, the fluid pressure communication port or ports 32 allow flushing fluid to more freely flow in the area of the locking device and the latches 142 thereby avoiding mud build up and function failure. The fluid pressure communication port or ports 32 also have the limited purpose of actuating the movable valve element 218 to the extent indicated above. This embodiment of the core barrel head assembly allows the creation of a fluid flow path with good straight flow reducing debris collecting pockets, fluid flow resistance and pumping pressure requirements.

The embodiment in FIGS. 12A-D and 13A-D differs from the one in FIGS. 11A-D and 11a-d in that the piston unit 307 is split such that it is comprised of a top piston 304 which connects to the piston rod 305 and a bottom piston 303 which connects to the valve rod 302. The top and bottom pistons are separated, and a space being formed, at occasions, between the top and bottom pistons is vented through the bottom bore 309 in the same way as the cylinder space 311. It should, however, be noted that the top piston does not have to be sealingly co-operating with the cylinder space 311, only that is co-operates with the biasing means 224.

In this embodiment, there is provided a separate locking device for the valve body, the valve rod 302 and the bottom piston 303 making up the movable valve element 218. In the shown embodiment, this is obtained by having a pin at the downstream position on the valve body cooperating with a bottom profiled slot 270′. Furthermore, the top piston 304, the piston rod 305 together with a latch lock 228, has a locking device corresponding to what is indicated in connection with the description of the embodiment in FIGS. 11A-D and 11a-d. By having separate locking devices such as in the embodiment in FIG. 12A, several advantages are obtained, i.a. that the biasing means 224 can be reset during the retrieval phase when a lifting wire being connected to the core barrel valve assembly is winded up on the surface.

FIGS. 12A and 13A shows the assembly in a descent phase, wherein it is pumped down into a drill string, and wherein the valve body 300 is locked in its closed position. In FIG. 13A is shown a bottom profiled slot 270′ wherein a pin 314 is seated in a locked position in an obliquely extending portion of the bottom profiled slot. 270 indicates a top profiled slot, wherein a pin 315 being associated with the piston rod 305 is similarly in its locked position.

FIGS. 12B and 13B shows the assembly in FIGS. 12A and 13A after having been subjected to high pressure, whereby a movable valve element 218 together with the top piston and the piston rod have been pressed to the left, as seen in the Figures, whereby both pins 314 and 315 have been forced into alignment with an axially extending portion of the respective profiled slots 270 and 270′. The reason for this displacement is similar to what has been described above in relation to previous described embodiments.

In FIGS. 12C and 13C, the assembly is shown after pressure having been released, whereby the biasing means 224 has pressed the piston unit 307 together with the valve body 300 to the right, as seen in the Figures, whereby the fluid flow path between the upstream and downstream fluid ports is free for pumped down flushing fluid, whereupon drilling can commence. Similar to the embodiment in FIG. 11, the fluid flow path is essentially without pockets or restrictions, thereby preventing failure because of mud build-up at sensitive positions. The respective pins 314 and 315 have reached a far end to the right, as seen in the Figures in the axially extending portion of the respective profiled slots. Simultaneously, a latch lock 228 has entered between latches 142 in order to secure them in the engagement position.

In FIGS. 12D and 13D the assembly is shown during the retrieval phase, whereby a force is applied to the spear head 50, whereby the retracting case 28 is moved relatively upwardly, to the left, as seen in the Figures, whereupon the top piston, and the piston rod 305 are moved so as to reset the upper locking device into locked position and pre-strain the spring being the biasing means 224. At the same time, the latch lock disengages the latches 142 and the latches are brought inwardly in similarity to what is explained above. The movable valve element 218 is unaffected by the movement of the retracting case 28 and remains in the open position allowing fluid present in the drill string to flow through the respective upstream and downstream fluid ports 40 and 38, respectively. This has the advantage that subsequently reset of the movable valve element 218 can be made more easily outside the drill string. This can be made manually or automatically through pressing a release mechanism to initiate a spring to move the movable valve element to the locked position.

When the latches 142 are in the retracted, disengaged position, the latch lock will interfere with the upper sides of the latches and secure further the top piston in an unlocked up-position, preventing the valve to open. This is a safety measure and an indication to the driller that the core barrel head assembly has not positioned properly, that the latches are not properly engaged and that drilling cannot start.

In FIG. 13D is shown a control window 316 in the retracting case 28 which over an oblique surface 317 cooperates with the pin 315 to position it in its locked position in the oblique portion of the profiled slot 270. This function basically as is explained above in relation to the first described embodiment of the invention.

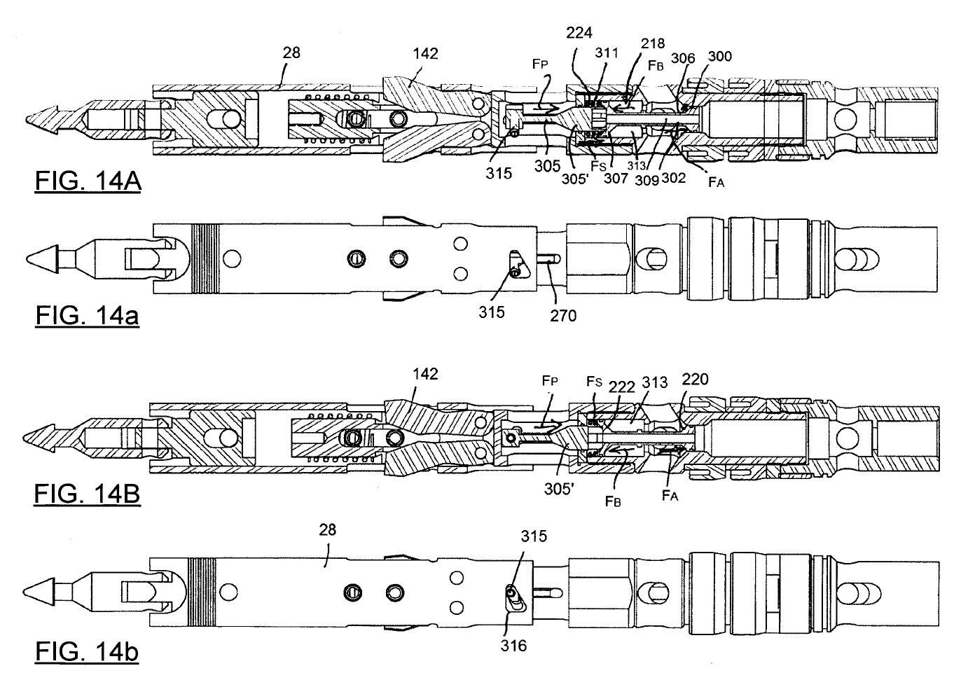

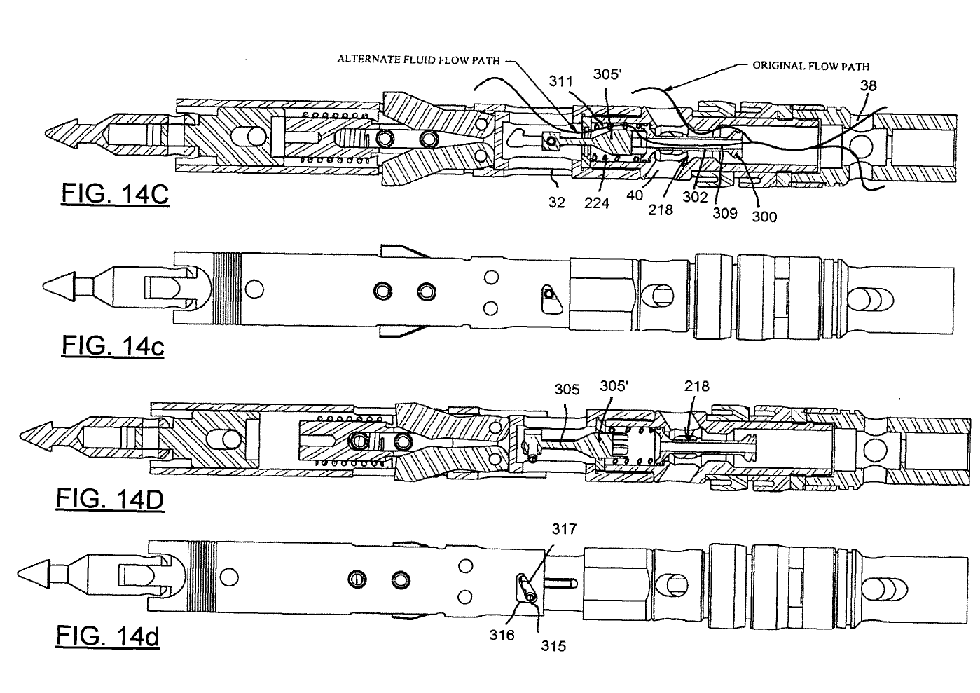

The embodiment in FIG. 14A-D and 14a-d functions basically as the one described above and has features in common with both the embodiments shown in FIGS. 11A-D and 12A-D. Basically, in this embodiment, the movable valve element 218 comprises a valve body 300 for co-operation with a valve seat 306 being in the form of an axially directed bore. The valve body 300 is connected to a valve rod 302, which on its other side, the opposite side being closest to the drilling machine, is connected to a piston unit 307. On its side opposite to the valve body 300, the piston unit 307 limits a cylinder space 311 which is also containing the biasing means 224 such as a spring. This embodiment can be designed so as to further eliminate pockets that might collect debris.

On its side opposite to the valve rod 302, the piston unit 307 is connected to a piston rod 305 which over an enlarged portion 305′ during the descent phase sealingly passes through an upper wall limiting the cylinder space 311 and supports, at its end being most distal from the piston unit 307, a pin 315 for the cooperation with a profiled slot 270, together forming a locking device essentially in correspondence with what has been described above.

The cylinder space 311 is vented over one or more openings 310 in the piston rod 305 and through a bore 309 inside the valve rod 302. The bore 309 opens into a low pressure space downstream of the valve body 300. Hereby the movable valve element 218 of this embodiment basically works in the same way as is described above in conjunction with FIGS. 11A-D and 11a-d, but is actuated essentially only by the fluid pressure prevailing in a space 313 between the first and second sides 220 and 222.

This embodiment works similar to the embodiment described in conjunction with FIGS. 11A-D when it comes to the descent (FIGS. 14A and a), the high pressure (FIGS. 14B and b) phases. In the open phase (FIGS. 14C and c), however, the enlarged portion has entered the cylinder space leaving an opened area inside the piston rod opening for a branch of the flushing fluid to flush through the cylinder space in order to flush out any debris that may have built up while the valve was closed. For that purpose, the enlarged portion comprises separated axial distance projections for contact with the valve element 218 so as to ensure a fluid flow path between the enlarged portion 305′ and the formed wall opening and the valve element and into and further through the bore 309 inside the valve rod 302. In FIG. 14C, these flow paths are illustrated with flow lines.

In the retrieve phase (FIGS. 14D and d), the valve element 218 has separated from the enlarged portion 305′, leaving the flow path between the ports 40 and 38 open, which is similar to the embodiment shown in FIGS. 12A-D. In FIG. 14d is shown a control window 316 in the retracting case 28 which over an oblique surface 317 co-operates with the pin 315 to position it in its locked position in the oblique portion of the profiled slot 270. This function basically as is explained above in relation to the first described embodiment of the invention. The piston rod 305 and its enlarged portion 305′ has been moved so as to close the opening in the wall limiting the cylinder space and preventing flushing flow. Reset of the pin 315 during the retrieve phase is similar as is described in conjunction with FIGS. 12A-d and 13A-D.

The valve element 218 regains it closed position once the descent phase is initiated by a force in the closing direction from flushing fluid pressure overcoming the forces acting in the opening direction (see above), thus bringing the valve element back into the position shown in FIG. 14A.

The present invention also provides a wire line core drill system comprising a wire line core drill having an inner tube by means of which core samples are collected, an outer tube connected to a drill bit, and a valve assembly situated at the rear end of the inner tube, said valve assembly controlling the supply of a flushing medium in the form of a pressurized fluid, wherein the valve assembly is constructed as described in one of the embodiments provided above.

Although preferred embodiments of the present invention have been described in detail herein and illustrated in the accompanying drawing, it is to be understood that the invention is not limited to these precise embodiments and that various changes and modifications may be effected therein without departing from the scope of the present invention. For example, the valve element can be comprised of one or more pieces. More than one locking mechanism can be present. The locking mechanism can be of any other type, such as a detent or ball lock type mechanism. Profiled slot or control window in latch retracting case is optional.

1. A valve assembly for use in a core barrel head assembly positionable within a drill string of a drilling apparatus, the valve assembly comprising:
a landing shoulder;
at least one upstream fluid port positionable within a fluid line of the drilling apparatus upstream of the landing shoulder;
at least one downstream fluid port positionable within the fluid line of the drilling apparatus downstream of the landing shoulder;
at least one fluid pressure communication port positionable within the fluid line of the drilling apparatus upstream of the landing shoulder;
a movable valve element having a first side in fluid communication with pressurized fluid through the at least one upstream fluid port and having a first surface that is influenced in the supply direction by a force from said pressurized fluid, and a second side facing in the opposite direction, in fluid communication with pressurized fluid through the at least one upstream fluid port and having a second surface that is influenced in the opposite direction by a force from said fluid;
wherein the movable valve element is also directly or indirectly influenced in the supply direction by a force from said pressurized fluid through the at least one fluid pressure communication port,
at least one biasing element for opening the valve assembly by displacing the valve element from a closed position to an open position, wherein the area of said second surface is greater than that of said first surface so that the force influencing the valve element in a closing direction, in the form of the force from the pressurized fluid acting on said second surface exceeds the force influencing the valve element in an opening direction, in a form of combining a force from the biasing element and the force from the pressurized fluid acting on said first surface and the force from said pressurized fluid through the at least one fluid pressure communication port, whereby the valve element is retained in a closed position of the valve when pressurized fluid is supplied.

2. The valve assembly according to claim 1, wherein, upon a reduction in the supply of pressurized fluid to the closed valve, a pressure force differential decreases between said first and second sides, and the biasing element then urges the valve element to be displaced from said closed position to said open position.

3. The valve assembly according to claim 1, further comprising:
at least one locking device for mechanically locking the valve element in said closed position.

4. The valve assembly according to claim 3, wherein the at least one locking device comprises any one from the group: a pin/bolt/stud-slot lock mechanism, a detent or ball lock type mechanism.

5. The valve assembly according to claim 3, wherein the valve element comprises:
a valve body comprising the second surface; and
a valve piston comprising:
a piston unit comprising the first surface;
a valve rod linking the piston unit to the valve body; and
a pin, bolt or a stud attached to piston element and projecting radially,
and wherein the at least one locking device comprises:
an upper latch body having a first profiled slot cooperating with the pin, bolt or stud, said first slot comprising a main portion extending along an axial direction and a secondary portion extending in a direction transverse to said axial direction; and
a latch retracting case coaxially displaceable with respect to the upper latch body and overlapping over the upper latch body, the latch retracting case having a second profiled slot or control window cooperating with the pin, bolt or stud, said second slot or control window extending along the axial direction and having a control surface extending in a direction transverse to said axial direction, essentially in parallel to the transverse direction in which the secondary portion of the first slot extends, said latch retracting case cooperating with a latch locking mechanism of the inner tube member, such that the latch retracting case prevents the latch locking mechanism from engaging with latches of the core barrel head assembly upon displacement of the pin, bolt or stud in the secondary portion of the first profiled slot.

6. The valve assembly according to claim 1, wherein the movable valve element comprises:
a valve body for co-operation with a valve seat, and
a piston unit co-operating with said valve body over a valve rod, wherein said first surface is comprised on the piston unit, and wherein said second surface is comprised on the valve body, said first and second surfaces facing each other.

7. The valve assembly according to claim 6, wherein the biasing element comprises a spring that is active against said piston unit.

8. The valve assembly according to claim 6, wherein said biasing element is placed inside a cylinder space which is vented through a bore in the valve rod to a position downstream of the landing shoulder.

9. The valve assembly according to claim 8, wherein said piston unit is connected to a locking device over a piston rod which passes through an end wall limiting said cylinder space.

10. The valve assembly according to claim 9, wherein said piston rod is arranged to pass sealingly through an opening in said end wall limiting said cylinder space in a closed position of the valve and pass allowing a flushing flow path through said opening in an open position of the valve.

11. The valve assembly according to claim 6, wherein the piston unit is connected to a piston rod, which is connected to at least one locking device for mechanically locking in said closed position.

12. The valve assembly according to claim 6, wherein the piston unit is controlled by a latch retracting case, which is connected to a spearhead for retrieval.

13. The valve assembly according to claim 6, wherein the piston unit is comprised of a top piston and a bottom piston, which are separable, wherein said first surface is comprised on said bottom piston of the piston unit.

14. The valve assembly according to claim 13, wherein said top piston and said bottom piston are each provided with an individual locking device for mechanically locking in said closed position.

15. The valve assembly according to claim 6, wherein the valve body and the piston unit are parts of an integral unit in one piece.

16. The valve assembly according to claim 6, wherein the valve element comprises:
a valve body comprising the second surface; and
a valve piston comprising:
a piston unit comprising the first surface;
a valve rod linking the piston unit to the valve body; and
a pin, bolt or a stud attached to piston element and projecting radially,
the valve assembly further comprising at least one locking device comprising
an upper latch body having a first profiled slot cooperating with the pin, bolt or stud, said first slot comprising a main portion extending along an axial direction and a secondary portion extending in a peripheral direction being oblique to said axial direction; and
a latch retracting case coaxially displaceable with respect to the upper latch body and overlapping over the upper latch body, the latch retracting case having a control window cooperating with the pin, bolt or stud, said control window extending along the axial direction and having a control edge extending in a peripheral direction being oblique to said axial direction, said latch retracting case cooperating with a latch locking mechanism of the inner tube member, such that the latch retracting case prevents the latch locking mechanism from engaging with latches of the core barrel head assembly upon displacement of the pin, bolt or stud with the control surface.

17. The valve assembly according to claim 16, wherein the peripheral direction being oblique to said axial direction is essentially parallel to the peripheral direction in which the secondary portion of the first slot extends.

18. The valve assembly according to claim 6, wherein a space for containing the biasing element is vented to a low pressure space.

19. The valve assembly according to claim 6, further comprising:
a latch rod arranged to prevent the valve from opening in case latches are not in an extended position.

20. The valve assembly according to claim 19, wherein the latch rod is coupled to the piston unit.

21. A method for operating a valve assembly for use in a core barrel head assembly positionable within a drill string of a drilling apparatus driven by pressurized fluid, the valve assembly comprising:
a landing shoulder;
at least one upstream fluid port positionable within a fluid line of the drilling apparatus upstream of the landing shoulder;
at least one downstream fluid port positionable within the fluid line of the drilling apparatus downstream of the landing shoulder;
at least one fluid pressure communication port positionable within the fluid line of the drilling apparatus upstream of the landing shoulder;
a movable valve element having a first side in fluid communication with pressurized fluid through the at least one upstream fluid port and having a first surface that is influenced in the supply direction by a force from said pressurized fluid, and a second side facing in the opposite direction, in fluid communication with pressurized fluid through the at least one upstream fluid port and having a second surface that is influenced in the opposite direction by a force from said fluid;
wherein the movable valve element is also directly or indirectly influenced in the supply direction by a force from said pressurized fluid through the at least one fluid pressure communication port,
at least one biasing element for opening the valve assembly by displacing the valve element from a closed position to an open position,
wherein the area of said second surface is greater than that of said first surface so that the force influencing the valve element in a closing direction, in the form of the force from the pressurized fluid acting on said second surface exceeds the force influencing the valve element in an opening direction, in a form of combining a force from the biasing element and the force from the pressurized fluid acting on said first surface and the force from said pressurized fluid through the at least one fluid pressure communication port, whereby the valve element is retained in a closed position of the valve when pressurized fluid is supplied, the method comprising:
supplying the pressurized fluid to the valve element in said closed position whereupon the valve assembly remains closed;
reducing the supply of pressurized fluid to the closed valve assembly; and
allowing a pressure force differential to decrease between said first and second sides, thereby enabling the biasing element to urge the valve element towards the open position, and thereby allowing fluid flow through the at least one upstream fluid port.

22. The method according to claim 21, wherein the valve assembly further comprises a locking device for mechanically locking the valve element in said closed position, wherein during supplying the pressurized fluid the valve element is in a mechanically locked closed position, the method further comprising:
causing the locking device to cease locking the valve element in the closed position after supplying the pressurized fluid.

23. The method according to claim 22, wherein supplying the pressurized fluid further comprises allowing fluid pressure to engage a latch lock of the latch locking mechanism.

24. The method according to claim 23, wherein the valve element comprises:
a valve body comprising the second surface; and
a valve piston comprising:
a piston unit comprising the first surface;
a valve rod linking the piston unit to the valve body; and
a pin, bolt or stud attached to the piston unit and projecting radially,
wherein the locking device comprises:
an upper latch body having a first profiled slot cooperating with the pin, bolt or stud,
said first slot comprising a main portion extending along an axial direction and a secondary portion extending in a peripheral direction being oblique to said axial direction; and
a latch retracting case coaxially displaceable with respect to the upper latch body and overlapping over the upper latch body, the latch retracting case having a control window cooperating with the pin, bolt or stud, said control window extending along the axial direction and having a control edge extending in a peripheral direction being oblique to said axial direction, said latch retracting case cooperating with a latch locking mechanism of the inner tube member, such that the latch retracting case prevents the latch locking mechanism from engaging with latches of the core barrel head assembly upon displacement of the pin, bolt or stud with the control surface, and wherein a causing the locking device to cease locking the valve element in the closed position further comprises displacing the pin, bolt or stud in said peripheral direction from the secondary portion to the main portion of the first profiled slot, upon proper deployment of the latch locking mechanism, thereby allowing axial movement of the piston unit.

25. A wire line core drill system, comprising:
a wire line core drill having an inner tube configured to collect core samples,
an outer tube connected to a drill bit, and
a valve assembly situated at a rear end of the inner tube, said valve assembly controlling a supply of a flushing medium comprising a pressurized fluid, wherein the valve assembly comprises
a landing shoulder,
at least one upstream fluid port positionable within a fluid line of the drilling apparatus upstream of the landing shoulder,
at least one downstream fluid port positionable within the fluid line of the drilling apparatus downstream of the landing shoulder,
at least one fluid pressure communication port positionable within the fluid line of the drilling apparatus upstream of the landing shoulder,
a movable valve element having a first side in fluid communication with pressurized fluid through the at least one upstream fluid port and having a first surface that is influenced in the supply direction by a force from said pressurized fluid, and a second side facing in the opposite direction, in fluid communication with pressurized fluid through the at least one upstream fluid port and having a second surface that is influenced in the opposite direction by a force from said fluid,
wherein the movable valve element is also directly or indirectly influenced in the supply direction by a force from said pressurized fluid through the at least one fluid pressure communication port,
at least one biasing element for opening the valve assembly by displacing the valve element from a closed position to an open position, wherein the area of said second surface is greater than that of said first surface so that the force influencing the valve element in a closing direction, in the form of the force from the pressurized fluid acting on said second surface exceeds the force influencing the valve element in an opening direction, in a form of combining a force from the biasing element and the force from the pressurized fluid acting on said first surface and the force from said pressurized fluid through the at least one fluid pressure communication port, whereby the valve element is retained in a closed position of the valve when pressurized fluid is supplied.
